(19) United States
(12) Patent Application Publication
(10) Pub. No.: US 2015/0014911 A1
(43) Pub. Date: Jan. 15, 2015

(54) VISE JAW INSERT SYSTEM AND METHOD OF USING THE SAME

(71) Applicant: Joseph Melanson, New Ipswich, NH (US)

(72) Inventor: Joseph Melanson, New Ipswich, NH (US)

(21) Appl. No.: 13/933,646

(22) Filed: Jul. 2, 2013

(51) Int. Cl. B25B 1/24

(52) U.S. Cl. CPC B25B 1/2452
USPC 269/282; 29/525.11

(57) ABSTRACT

A vise jaw insert system adapted to be mounted on a vise jaw including a plurality of attachment members, each attachment member having a head portion and a threaded portion, and a jaw insert member having a first workable surface and an opposing second workable surface, wherein the jaw insert member includes an insertion hole having a first cross-section shape and a different second cross-section shape extending from the first workable surface to the second workable surface.

### CROSS-REFERENCE TO RELATED APPLICATIONS

This application claims the benefit of U.S. Provisional Patent Application No. 61/666,959, filed on Jul. 2, 2012, the disclosure of which is incorporated herein in its entirety by reference.

### BACKGROUND

1. Field of the Invention

The present inventive concept relates to a system and method for securing a work piece. More particularly, the present general inventive concept relates a quick replaceable vise jaw insert usable with a conventional vise, and a method of using the same.

2. Description of the Related Art

Several systems currently exist that allow a user to secure a work piece to a work station. In certain applications, this workstation includes a vise. In a simple form, a vise includes means in which a work piece is compressed between a pair of opposing vise jaws such that the compressive forces are sufficient to secure the work piece in a desired location. Often, the desired location is relative to other devices and actions, for example, when it is intended that the work piece be milled. Typically, these vises include a movable, or compressive, vise jaw and a stationary jaw. Over the years a variety of inserts and attachments to the vise jaws have been developed to advance the state of the art.

Related art vises and related components may include a means for attaching and removing vise jaws from a vise to accommodate unique work pieces. For example, the patent granted to Nickas, Jr., U.S. Pat. No. 2,646,708 discloses a vise jaw combination that employs a spring with a set screw to lock a jaw face in position. The jaw face may be rotated to allow for varying work piece surfaces and shapes.

With the need for different jaw shapes and surfaces came the need to make the removal and reattachment of vise jaws more efficient. Several devices have been developed with this aim in mind. Wight, et al., U.S. Pat. No. 4,602,772 discloses a replaceable vise jaw insert assembly that is designed to allow for removal and reattachment of vise jaw inserts. Additionally, related art devices intending to speed up removal and attachment times for vise jaw inserts and the like disclose modifications to the attachment means of the vise jaws. U.S. Pat. No. 6,045,126 discloses a fastening member that comprises a “bolt within a bolt” configuration. These fastening members are intended to provide for removal and reattachment of jaw inserts that do not require any realigning of the existing jaws.

Other attachment means and insert assemblies may include jaw insert assemblies that may include soft inserts into which templates of the work pieces may be cut. An example of this may be found in U.S. Pat. No. 6,773,003 to Dermody, Jr.

Other devices have also attempted to provide so-called “quick-change” vise jaw assemblies. For example, the patent application to Garrison, U.S. Application Publication No. 2004/0032071 discloses vise jaw inserts that include slotted holes on their rear face. When placed over a bolt extending from the vise jaw, the insert can than be slid into position and retained via spring tension. Cam-lock style attachment means have also been used, as can be seen in the Published Application No. 2010/0181714 to Calhout, et al.

However, while these and other prior art devices may be suitable for their intended applications, none of them solve the various problems addressed by the present inventive concept. In particular, the conventional prior art devices provide jaw inserts having only a single usable work surface, which increases replacement costs. The work surface is used to secure a work piece to the workstation.

That is, what is needed is a jaw insert which is quickly and easy to replace and which includes multiple usable work surfaces to reduce replacement time and costs.

### BRIEF SUMMARY OF THE INVENTION

The present general inventive concept provides a system for securing a work piece in a quick and efficient manner and a method for securing a work piece in a quick and efficient manner.

The present general inventive concept further provides a system for securing a work piece, wherein the system may comprise a vise, at least one attachment member and at least one vise jaw.

The present general inventive concept further provides a system for securing a work piece wherein a vise jaw may be removed and/or attached by a user with minimal effort and with minimal expenditure of time.

The present general inventive concept further provides a system for securing a work piece, wherein the system may comprise a vise, at least one vise jaw, and at least one attachment member and wherein the at least one attachment member further comprises a locking shape that may correspond to a locking slot within the vise jaw.

The present general inventive concept further provides a jaw insert that may include multiple usable work surfaces.

Additional aspects and utilities of the present general inventive concept will be set forth in part in the description which follows and, in part, will be obvious from the description, or may be learned by practice of the general inventive concept.

The foregoing and/or other aspects of the present general inventive concept may be achieved by providing a vise jaw insert system adapted to be mounted on a vise jaw which includes a plurality of attachment members, each attachment member having a head portion and a threaded portion, and a jaw insert member having a first workable surface and an opposing second workable surface, wherein the jaw insert member includes an insertion hole having a first cross-section shape and a different second cross-section shape extending from the first workable surface to the second workable surface.

The head portion may include a cross-section shape, which corresponds to the first cross-section shape of the insertion hole.

The jaw insert member may be secured to the vise jaw when the head portion is aligned and inserted into the first cross-section shape of the insertion hole and then rotated.

The head portion may be disposed between the second workable surface and the first cross-section shape of the insertion hole.

A rotation of the head portion may secure the attachment member to the jaw insert member.

A rotation angle of the head portion may be between 1 and 90 degrees.

The foregoing and/or other aspects of the present general inventive concept may also be achieved by providing a method of using a vise jaw insert system adapted to be mounted on a vise jaw, the vise jaw insert system including a plurality of attachment members, each attachment member having a head portion and a threaded portion and a jaw insert member having a first workable surface and an opposing second workable surface, wherein the jaw insert member includes an insertion hole having a first cross-section shape and a different second cross-section shape extending from the first workable surface to the second workable surface, the method includes securing at least one attachment member to a vise jaw, aligning the head portion of the attachment member with the first cross-section shape of the jaw insert member, pressing the first workable surface of the jaw insert member against the vise jaw, and rotating the attachment member to a rotation angle to secure the jaw insert member to the vise jaw, wherein the second workable surface is exposed to contact a work piece.

The jaw insert may be rotated such that the first workable surface is exposed when the second workable surface has been worn out.

The foregoing and/or other aspects of the present general inventive concept may be also achieved by providing a device for securing a work piece including a vise comprising a vise body, a fixed vise jaw and a movable vise jaw, a means for engaging said fixed vise jaw and a movable vise jaw; at least one fixed member, at least one jaw insert capable of attaching to said fixed vise jaw and/or said movable vise jaw, wherein said jaw insert comprises an insert body, wherein said insert body further comprises portions defining attachment ports and wherein said attachment ports comprise an alignment slot and a locking portion, at least one attachment member, wherein said attachment member comprises an alignment head, wherein said alignment head further comprises a pair of opposing substantially circular shaped portions, and a pair of opposing, straight edged portions, wherein said pair of opposing substantially circular shaped portions, and pair of opposing, straight edged portions are capable of engaging with said attachment ports in a desired locking manner, and an attachment tool, wherein said attachment tool comprises portions capable of engaging said attachment members to a desired locked or unlocked position.

The foregoing and/or other aspects of the present general inventive concept may be also achieved by providing a securing device including at least one fixed member, at least one insert member that may be engaged with an attachment tool to said fixed member, wherein said insert member comprises an insert body, and wherein said insert body further comprises portions defining attachment ports and wherein said attachment ports comprise an alignment slot and a locking portion, and an attachment tool, wherein said attachment tool comprises portions capable of engaging said attachment members to a desired locked or unlocked position.

The foregoing and/or other aspects of the present general inventive concept may be also achieved by providing a method of using a securing device on an object, the securing device including at least one insert having a first shaped through hole and a second shaped partial through hole, and at least one attachment member with a head portion having a shape corresponding to the second shaped partial through hole, the method includes attaching the at least one attachment member to the object, aligning the head portion of the attachment member with the second shaped partial through hole of the at least one insert, pressing the at least one insert against the object, and tightening the attachment member such that the second shape of the head portion is perpendicular to the second shaped partial through hole of the insert.

### BRIEF DESCRIPTION OF THE DRAWINGS

The general inventive concept is further described in the detailed description that follows, by reference to the noted drawings by way of non-limiting illustrative exemplary embodiments of the general inventive concept, in which like reference numerals represent similar parts throughout the drawings. As should be understood, however, the general inventive concept is not limited to the precise arrangements and instrumentalities illustrated.

An exemplary embodiment of the present general inventive concept, which in no way limits the claims will now be more particularly described by way of example with reference to the accompanying drawings, wherein:

FIG. 1 is a perspective view of a conventional vise jaw of the type adapted for use with replaceable inserts on the vise jaws;

FIG. 2 is a perspective exploded assembly view of a jaw insert system including a jaw insert member and an attachment member according to an exemplary embodiment of the present general inventive concept;

FIG. 3 is a top view of the jaw insert member illustrated in FIG. 2;

FIG. 4 is a front view of the jaw insert member illustrated in FIG. 2;

FIG. 5 is a side view of the jaw insert member illustrated in FIG. 2;

FIG. 6 is a perspective side view of the insert member illustrated in FIG. 2, showing hidden lines;

FIGS. 7 through 14 illustrates a method of using the jaw insert system according to an exemplary embodiment of the present general inventive concept;

FIG. 15 is a flow chart illustrating the method shown in FIGS. 7 through 14;

FIG. 16 is a cross-section view of the jaw insert system when the attachment member is aligned with the insertion hole;

FIG. 17 is a cross-section view of the jaw insert system of the attachment member secured to the jaw insert member;

FIG. 18 is a perspective view illustrating hidden lines of a jaw insert member according to another exemplary embodiment of the present general inventive concept; and

FIG. 19 is front view illustrating hidden lines of the jaw insert member illustrated in FIG. 18.

### DETAILED DESCRIPTION OF THE PREFERRED EMBODIMENTS

The present inventive concept will now be described more fully with reference to the accompanying drawings, in which exemplary embodiments of the present general inventive concept are illustrated. The inventive concept may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals refer to like elements throughout.

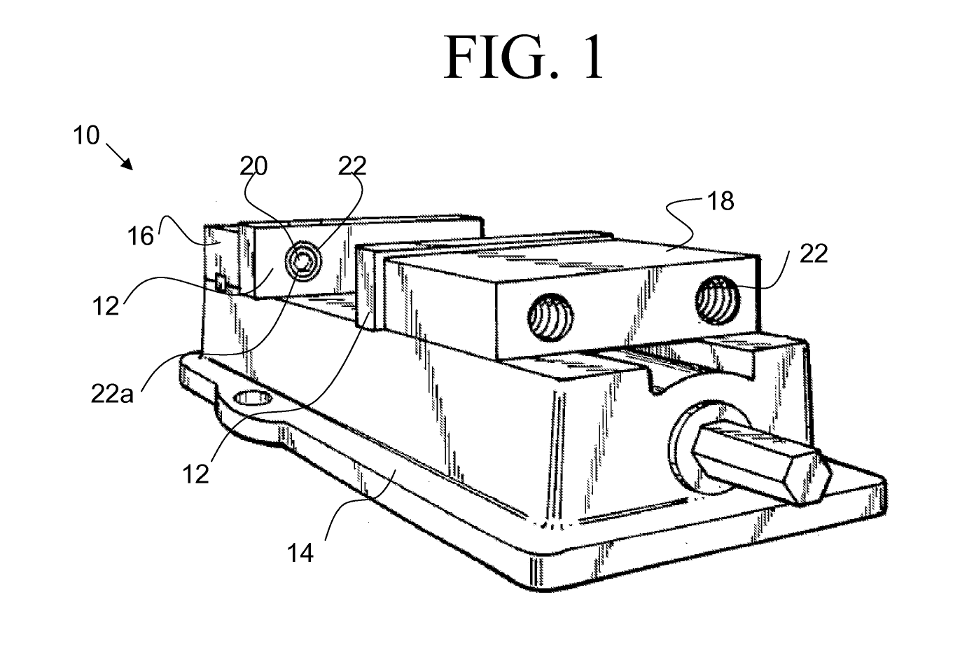

FIG. 1 is a perspective view of a conventional vise jaw 10 of the type adapted for use with replaceable inserts on the vise jaws.

Referring to FIG. 1, the conventional vise jaw 10 is of the type adapted for use with replaceable vise jaws inserts 12. The vise jaw 10 includes a base member 14 on which a stationary vise jaw 16 and a movable vise jaw 18 are mounted. Replaceable vise jaws inserts 12 are secured to the stationary vise jaw 16 and to the movable vise jaw 18 by using threaded screws 20. The threaded screws 20 are inserted into the vise jaws inserts 12 and fastened to the threaded holes 22 of the vise jaws 16, 18.

However, the threaded screws 20 must be rotated several times until a head portion of the threaded screw 20 engages with a counter bored portion of the vise jaw insert 12. This requires a substantial amount of time and energy to complete the replacement for each new vise jaw insert 12. Moreover, in order to remove and replace the vise jaw insert 12, a user must reverse the rotation of the threaded screws 20 to completely unthread the screws 20 from the vise jaw to remove the vise jaw inserts 12.

In contrast, a jaw insert system 1000 according to the present general inventive concept is adapted to allow for a quick replacement of the insert members 100 on to a work station, such as the conventional vise jaw 10. A user may place a work piece onto a work station (i.e., a conventional vise illustrated in FIG. 1), in between a stationary vise jaw 16 and a movable vise jaw 18.

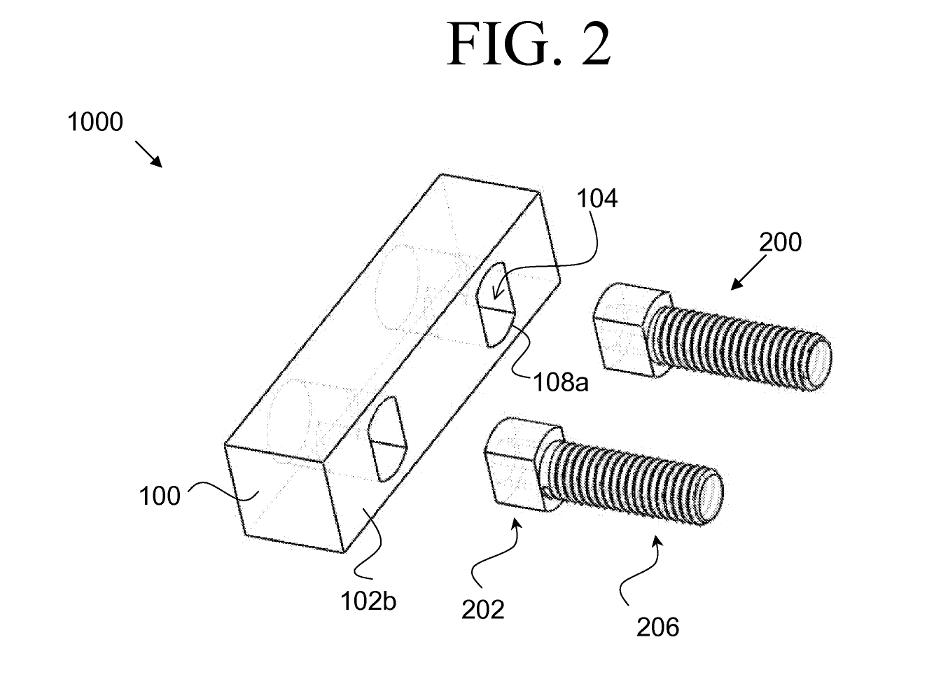

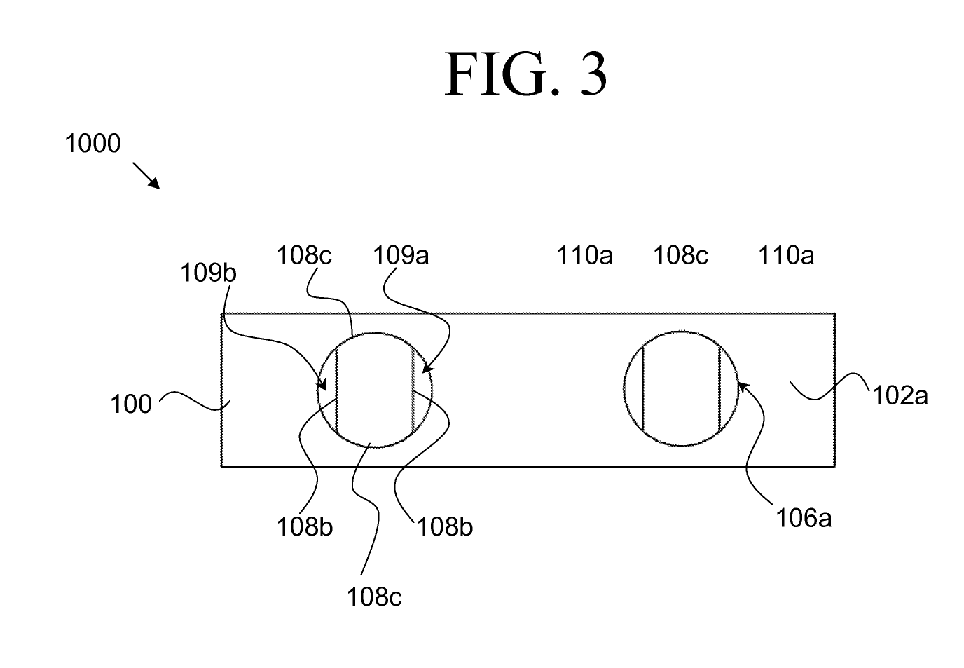

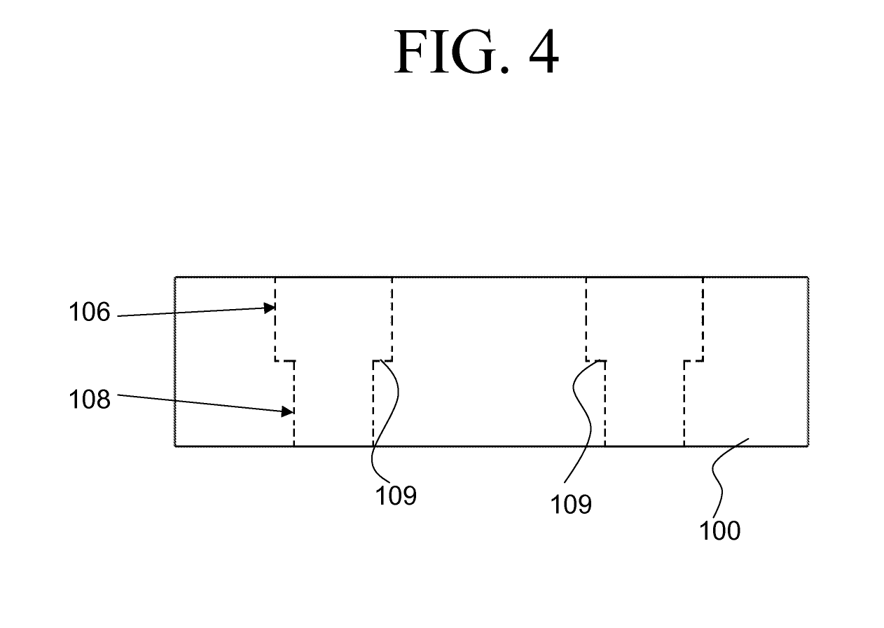

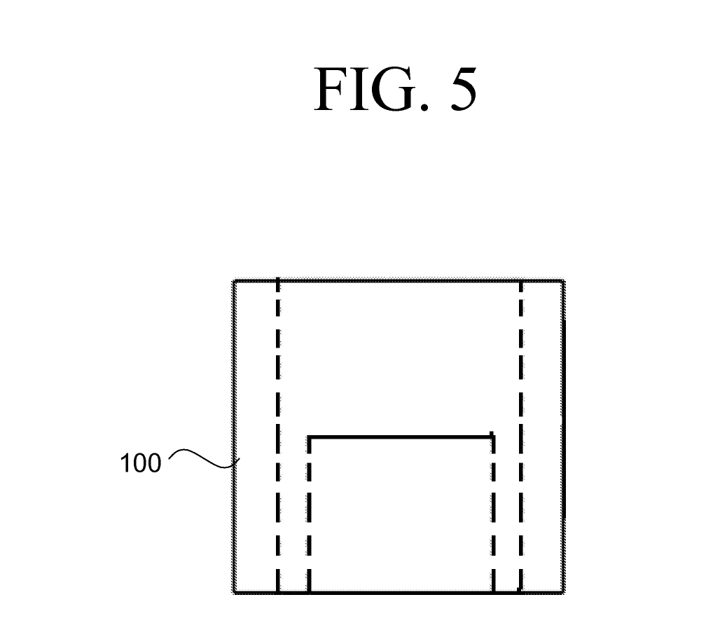

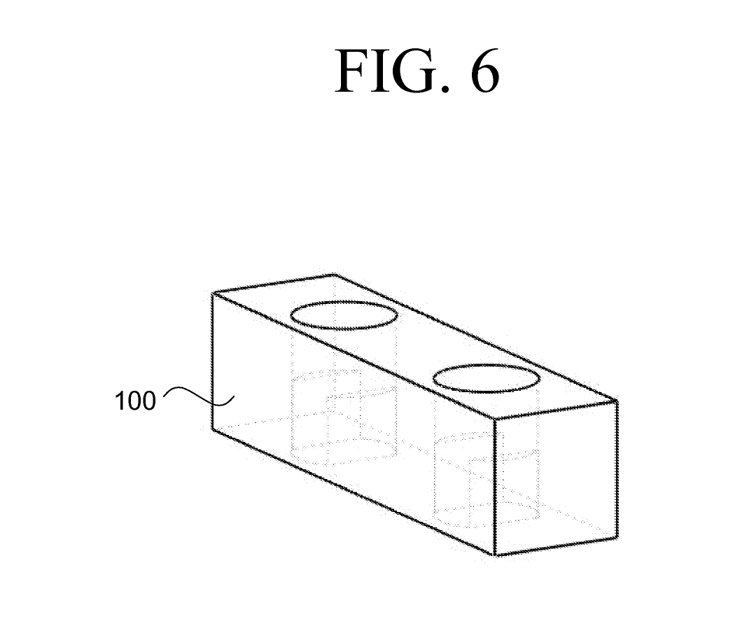

FIG. 2 is a perspective exploded assembly view of a jaw insert system 1000 including a jaw insert member 100 and an attachment member 200 according to an exemplary embodiment of the present general inventive concept, FIG. 3 is a top view of the jaw insert member 100 illustrated in FIG. 2, FIG. 4 is a front view of the jaw insert member 100 illustrated in FIG. 2, FIG. 5 is a side view of the jaw insert member 100 illustrated in FIG. 2, and FIG. 6 is a perspective side view of the insert member 100 illustrated in FIG. 2, showing hidden lines.

Referring to FIGS. 2-6, the jaw insert system (generally indicated at 1000) according to an exemplary embodiment of the present general inventive concept includes an insert member 100 and a plurality of attachment members 200.

In exemplary embodiments, the insert member 100 includes a first surface 102a and an opposing second surface 102b. The second surface 102b may be coupled to a planar surface of a workstation, such as a conventional vise jaw (not illustrated). That is, the insert member 100 may be coupled to a conventional vise jaw 10 such that the second surface 102b is substantially perpendicular to a work surface and the first surface 102a is pressed against and coupled to the vise jaw. In exemplary embodiments, the jaw insert member 100 may be formed in a substantially rectangular shape, however the present general inventive concept is not limited thereto. That is, the jaw insert member 100 may be formed in various sizes and shapes to correspond to a size and shape of a desired vise or work station.

The insert member 100 includes at least one insertion hole 104 which extends from the first surface 102a toward the second surface 102b. Sidewalls of the insert member 100 surrounding the insertion hole 104 may include a first portion 106 formed in a first shape 106a and a second portion 108 formed in a second shape 108a. In an exemplary embodiment, the first shape 106a is different that the second shape 108a.

In the present exemplary embodiment, the first portion 106 of the insertion hole 104 is formed in a substantially circular shape and the second portion 108 includes a pair of opposing walls 108b and opposing substantially circular walls 108c. (See FIG. 3). However, the present general inventive concept is not limited thereto. That is, the first portion 106 and the second portion 108 may be formed in various shapes and configurations.

The insert member 100 further includes an engagement member 109 disposed within the insertion hole 104. In an exemplary embodiment, the engagement member 109 includes at least one engagement surface 109a. In the present exemplary embodiment, the engagement member 109 is disposed in between the first surface 102a and the second surface 102b and includes a plurality of engagement surfaces 109a, 109b.

As illustrated in FIG. 3, the first and second surfaces 109a, 109b of the engagement member 109 and a portion of the insertion hole 106 form a second shaped insertion portion 108a.

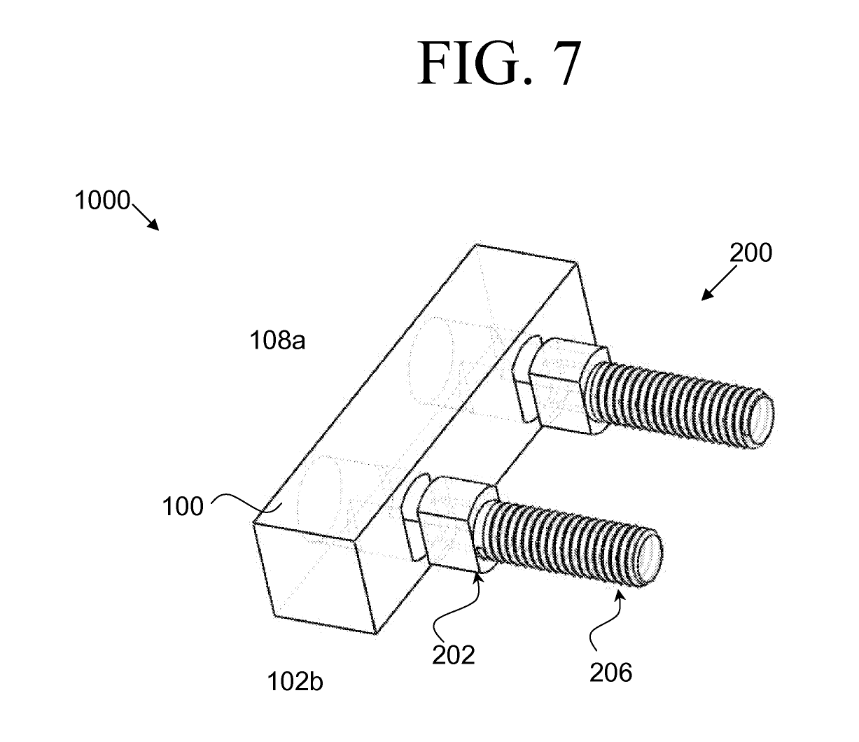

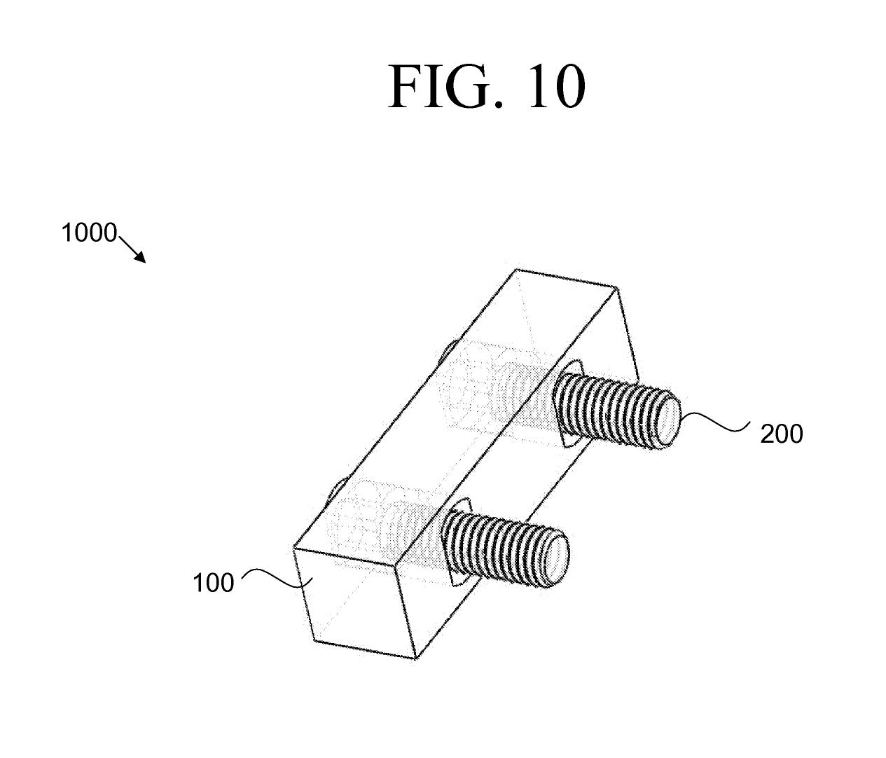

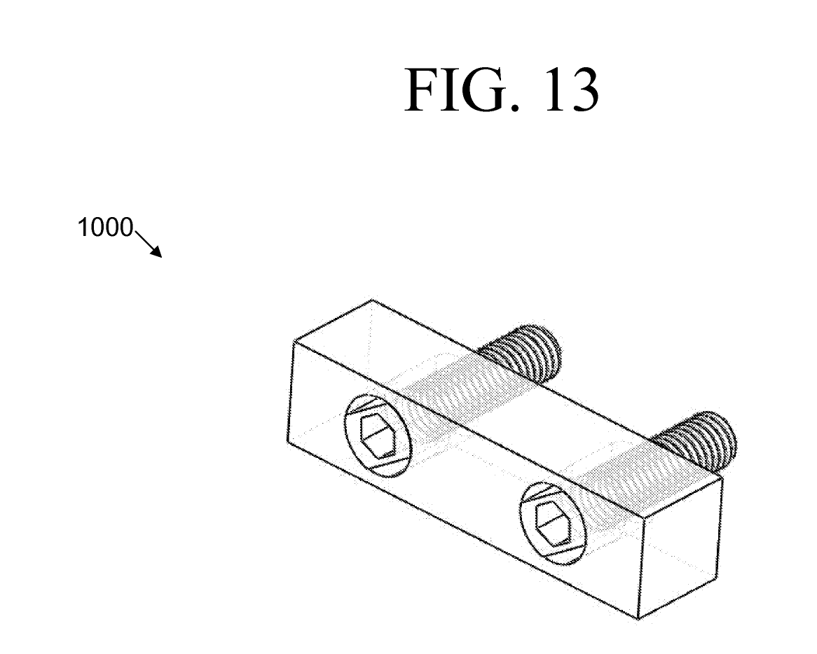

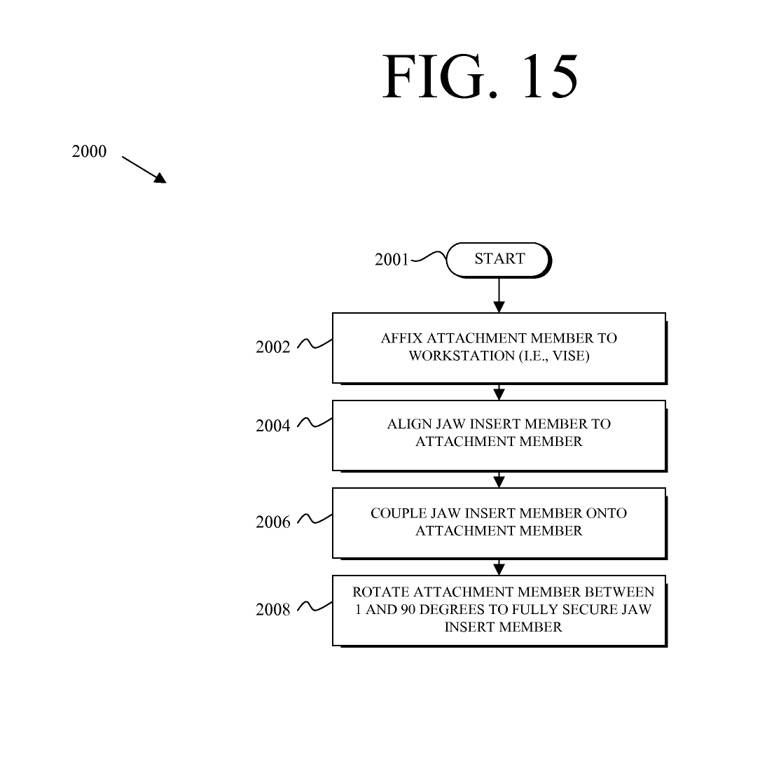

FIGS. 7 through 14 illustrates a method of using the jaw insert system 1000 according to an exemplary embodiment of the present general inventive concept. FIG. 15 is a flow chart illustrating the method shown in FIGS. 7 through 14.

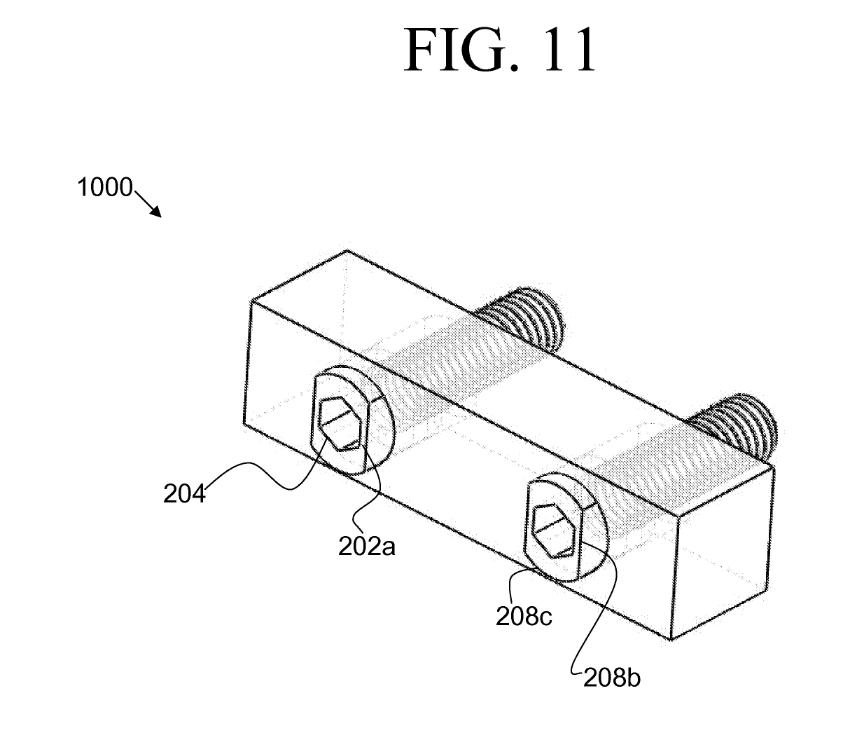

The plurality of attachment members 200 includes a head portion 202 having a tool engagement member 204, and a threaded portion 206. As illustrated in FIG. 11, the head portion 202 is formed with a head shape 202a. In exemplary embodiments, the head shape 202a corresponds to the second shape 108a of the insertion hole 104.

The head portion 202 includes a first portion 208b which corresponds to a size and shape of the pair of opposing walls 108b of the insertion hole 104, and a second portion 208c which corresponds to a size and shape of the opposing substantially circular walls 108c of the insertion hole 104. That is, in an exemplary embodiment, the head portion 202 comprises opposing substantially circular shaped portions 208c and a pair of opposing straight edged portions 208b.

In an exemplary embodiment, the insert member 100 may be coupled onto the plurality of attachment members 200 when the circular shaped portions 208c and the pair of opposing straight edged portions 208b are aligned with the pair of opposing walls 108b the opposing substantially circular walls 108c of the insertion hole 104, respectively.

In exemplary embodiments, the plurality of attachment members 200 may be detachably coupled to the insert member 100 based on an orientation of the head portion 202 with respect to the insertion hole 104.

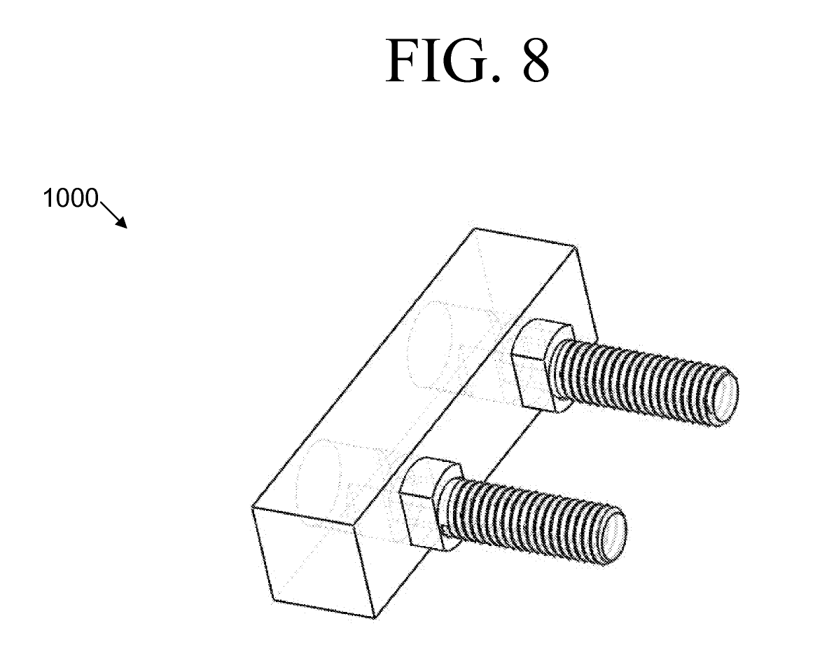

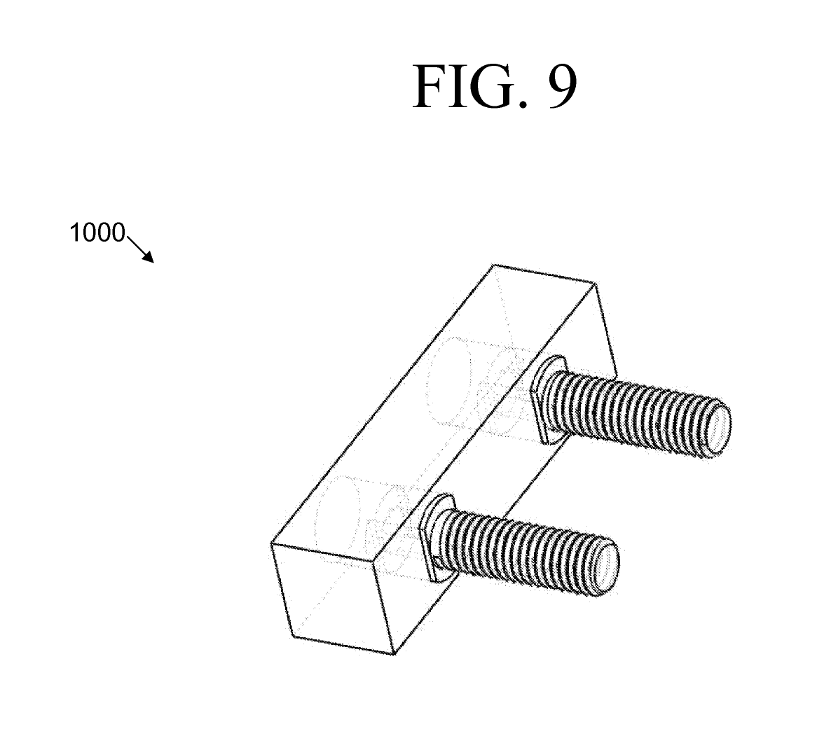

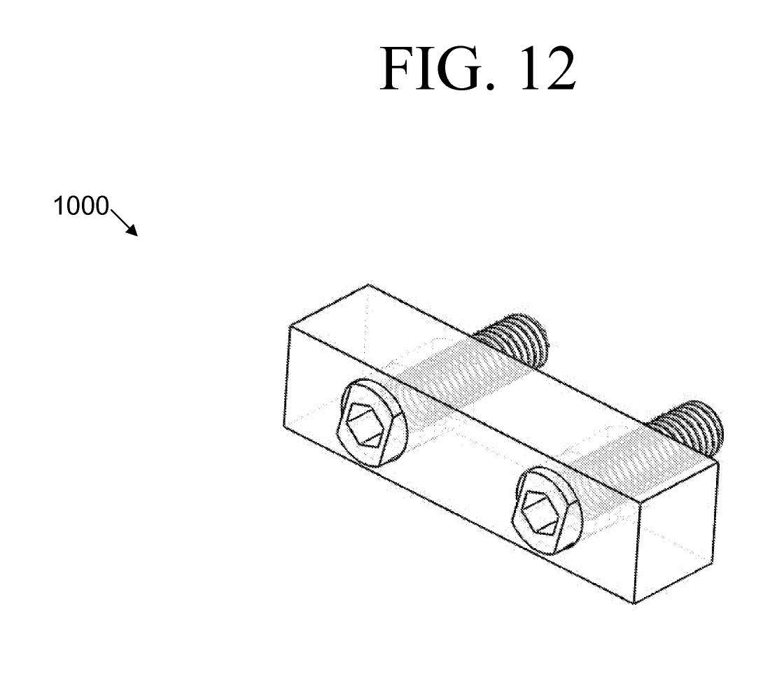

In an exemplary embodiment, the method 2000 of using the jaw insert system 1000 includes the following steps. First, at least one attachment member 200 is affixed to a workstation, such as a conventional vise jaw (Step 2002). Next, an insert member 100 is positioned adjacent to a head portion 202 of the attachment members 200. (See FIG. 7). Next, the insert member 100 is positioned such that the second portion 108 of the insertion hole 104 is aligned with the head portion 202 of the attachment member 200 (Step 2004, See FIG. 8). The insert member 100 is then coupled onto the head portion 202 of the attachment member 200 (Step 2006). (See FIG. 9). Next, a tool (not illustrated) may be inserted into the tool engagement member 204 to rotate the attachment member 200 between 1 and 90 degrees to fully secure the jaw insert member 100 to a work station or vise (Step 2008). (See FIGS. 12-14).

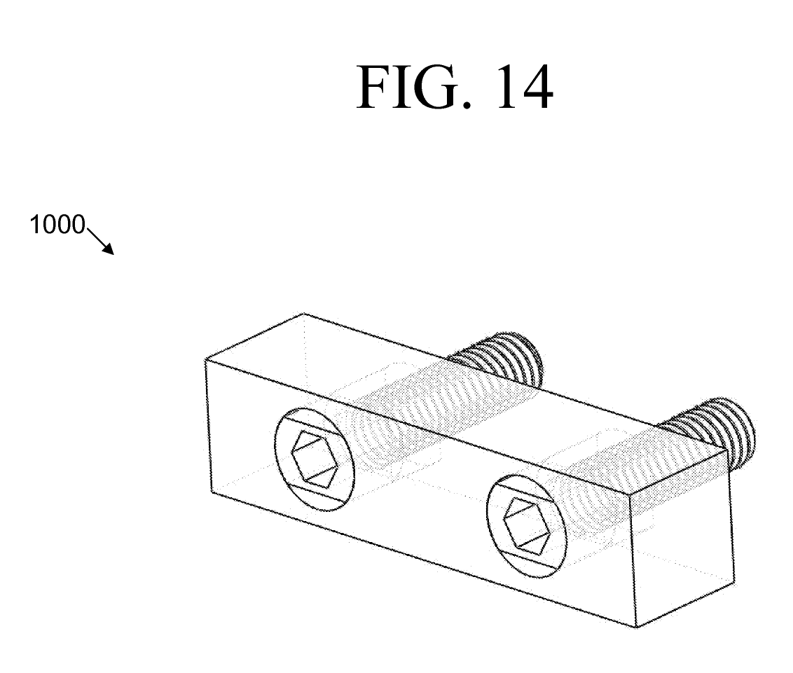

In exemplary embodiments, the attachment member 200 is rotated to an engagement angle A1 so as to secure the insert member 100 to the workstation. (See FIG. 14). In exemplary embodiments, the engagement angle may range between 1° to 90°, however the present general inventive concept is not limited thereto. (See FIGS. 12-14).

In an alternative exemplary embodiment, the insert member 100 is initially not engaged with a fixed member of a workstation, such as a vise, which includes either a fixed or a movable jaw of a vise. The attachment members are secured into the fixed member, preferably by means of threading located substantially on an outer portion of the attachment members. Upon reaching the desired thread depth, the attachment members are in an aligned position. The aligned position is preferably a substantially vertical position. The jaw insert may then be slid over the attachment members utilizing the attachment slots therein. Upon desired seating of the jaw insert over the attachment members, the attachment members are then secured relative to the attachment slots by means of an attachment tool. Preferably the attachment members are rotated ninety degrees to provide the desired secured attachment. This method may be repeated with additional attachment members, jaw inserts and fixed members as desired. Once the jaw insert or inserts are fixed in a desired attached position, the work piece may be positioned and secured into place through manipulation of the vise.

In a second preferred embodiment, the jaw insert or inserts are initially engaged with a fixed member or members, which in a preferred embodiment comprises a vise and vise jaw or vise jaws. If desired, the user may utilize an attachment tool to reposition the attachment members into an aligned position. Upon reaching an aligned position, the jaw insert or inserts may then be disengaged relative to the fixed member.

The engagement and disengagement of the jaw inserts relative to a fixed member or members may be repeated as often as desired. The engagement or disengagement process may be completed quickly and efficiently in a matter of mere moments or less. The present invention therefore allows for quick and efficient securing and removal of a work piece in a manner not currently found in the art. The attachment members may further include an inclined surface to further aid in the attachment to the jaw inserts. In an exemplary embodiment, the edges of the surface of the attachment members making contact with the jaw insert may be chamfered or angled in order to aid in the attachment of the attachment member to the jaw insert member.

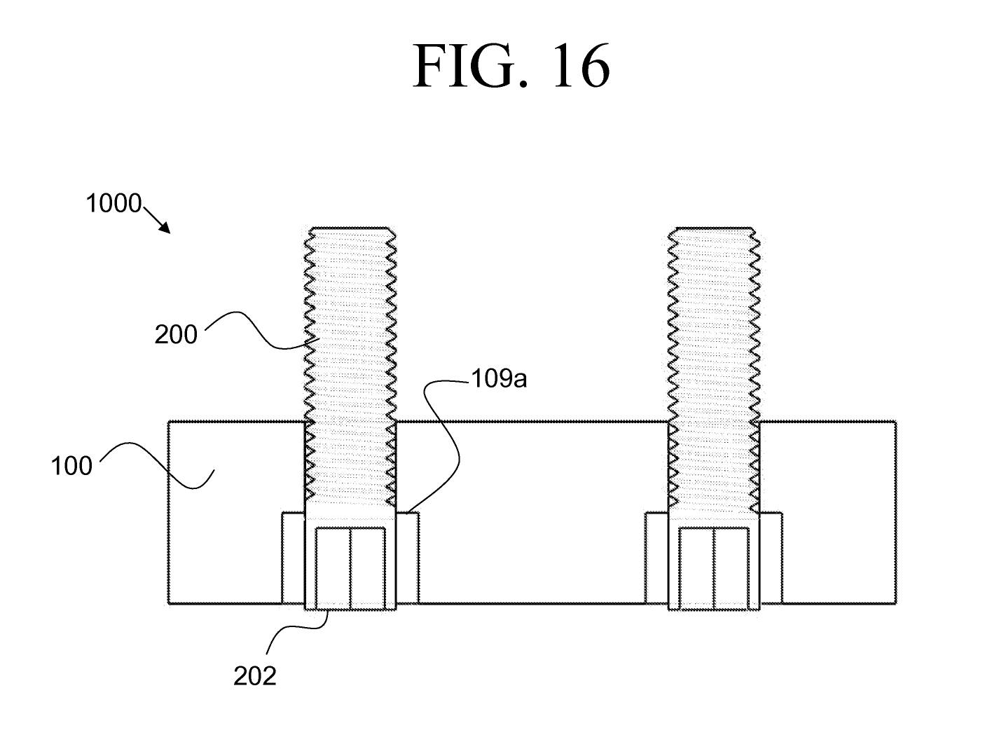

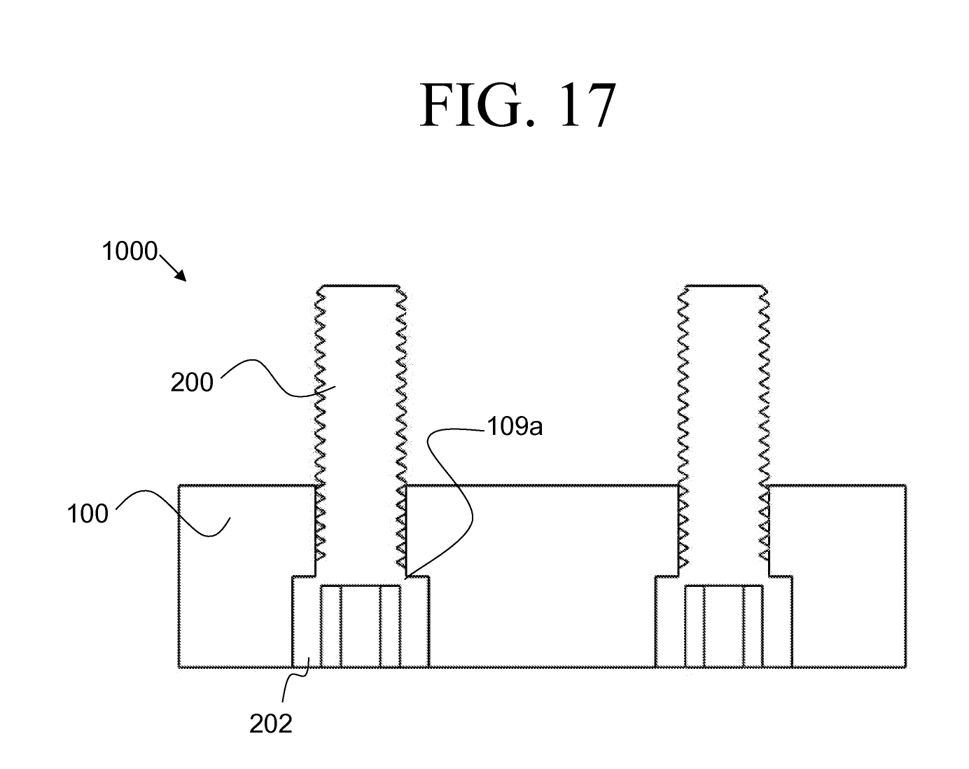

FIG. 16 is a cross-section view of the jaw insert system when the attachment member is aligned with the insertion hole and FIG. 17 is a cross-section view of the jaw insert system of the attachment member secured to the jaw insert member.

Referring to FIG. 16, the head portion 202 of the attachment members 200 is aligned with the insertion hole 104 to be removed from the workstation or vise.

Referring to FIG. 17, the head portion 202 of the attachment members 200 is rotated 90 degrees to secure the jaw insert member 100 to the workstation or vise. As illustrated, when the attachment members 200 are rotated to a desired engagement angle A1, the head portion 202 contacts the engagement surface 109a.

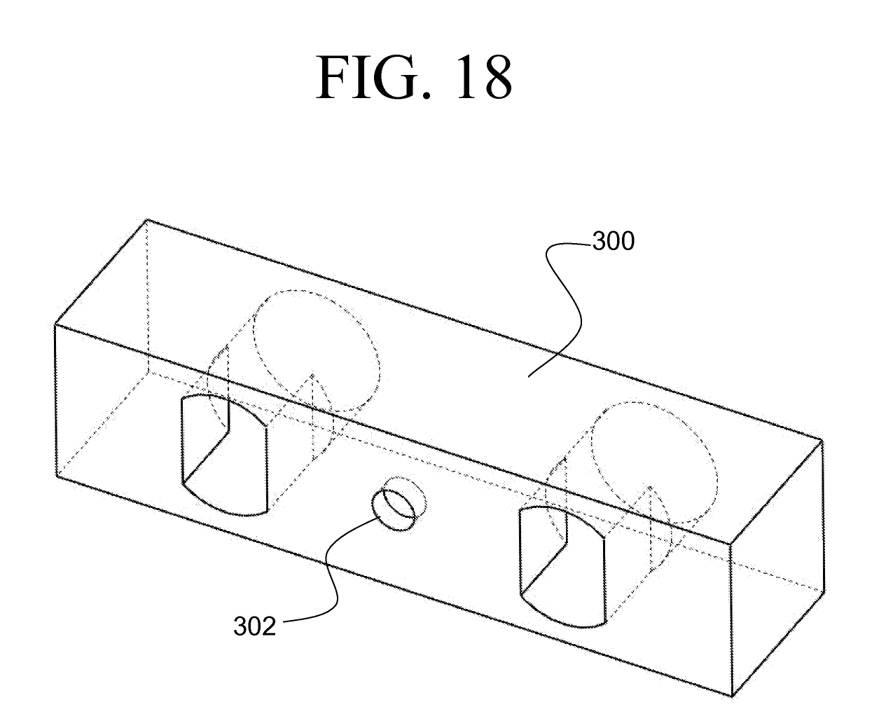

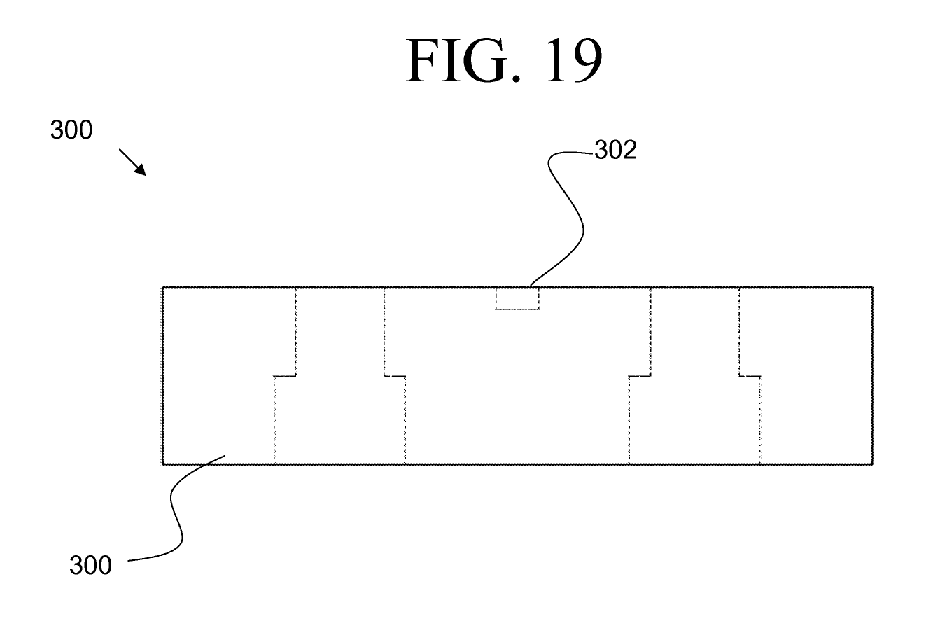

FIG. 18 is a perspective view illustrating hidden lines of a jaw insert member 300 according to another exemplary embodiment of the present general inventive concept and FIG. 19 is front view illustrating hidden lines of the jaw insert member 300 illustrated in FIG. 18.

Referring to FIGS. 18-19, the jaw insert member 300 is substantially similar to the embodiments described above. In addition, the jaw insert member 300 includes an alignment hole 302, in while a dowel may be inserted to further aid in the alignment and assembly of the jaw insert member 300 to a workstation or vise.

It is to be understood that the foregoing illustrative exemplary embodiments have been provided merely for the purpose of explanation and are in no way to be construed as limiting of the present general inventive concept. For example, the alignment head may be smooth or comprise additional locking features such as a grooved portion that may engage with a raised portion within the alignment slots of the jaw inserts. Words used herein are words of description and illustration, rather than words of limitation. In addition, the advantages and objectives described herein may not be realized by each and every exemplary embodiment practicing the present general inventive concept. Further, although the present general inventive concept has been described herein with reference to particular structure, steps and/or exemplary embodiments, the present general inventive concept is not intended to be limited to the particulars disclosed herein. Rather, the present general inventive concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the present general inventive concept.

What is claimed is:

1. A vise jaw insert system adapted to be mounted on a vise jaw comprising:
a plurality of attachment members, each attachment member having a head portion and a threaded portion; and
a jaw insert member having a first workable surface and an opposing second workable surface,
wherein the jaw insert member includes an insertion hole having a first cross-section shape and a different second cross-section shape extending from the first workable surface to the second workable surface.

2. The vise jaw insert system of claim 1, wherein the head portion includes a cross-section shape which corresponds to the first cross-section shape of the insertion hole.

3. The vise jaw insert system of claim 2, wherein the jaw insert member is secured to the vise jaw when the head portion is aligned and inserted into the first cross-section shape of the insertion hole and then rotated.

4. The vise jaw insert system of claim 3, wherein the head portion is disposed between the second workable surface and the first cross-section shape of the insertion hole.

5. The vise jaw insert system of claim 4, wherein a rotation of the head portion secures the attachment member to the jaw insert member.

6. The vise jaw insert system of claim 5, wherein a rotation angle of the head portion is between 1 and 90 degrees.

7. A method of using a vise jaw insert system adapted to be mounted on a vise jaw, the vise jaw insert system including a plurality of attachment members, each attachment member having a head portion and a threaded portion and a jaw insert member having a first workable surface and an opposing second workable surface, wherein the jaw insert member includes an insertion hole having a first cross-section shape and a different second cross-section shape extending from the first workable surface to the second workable surface, the method comprising:
securing at least one attachment member to a vise jaw;
aligning the head portion of the attachment member with the first cross-section shape of the jaw insert member;
pressing the first workable surface of the jaw insert member against the vise jaw; and
rotating the attachment member to a rotation angle to secure the jaw insert member to the vise jaw,
wherein the second workable surface is exposed to contact a work piece.

8. The method of claim 7, wherein the jaw insert may be rotated such that the first workable surface is exposed when the second workable surface has been worn out.

9. A device for securing a work piece comprising:
a vise comprising a vise body, a fixed vise jaw and a movable vise jaw, a means for engaging said fixed vise jaw and a movable vise jaw; at least one fixed member;
at least one jaw insert capable of attaching to said fixed vise jaw and/or said movable vise jaw, wherein said jaw insert comprises an insert body, wherein said insert body further comprises portions defining attachment ports and wherein said attachment ports comprise an alignment slot and a locking portion;
at least one attachment member, wherein said attachment member comprises an alignment head, wherein said alignment head further comprises a pair of opposing substantially circular shaped portions, and a pair of opposing, straight edged portions, wherein said pair of opposing substantially circular shaped portions, and pair of opposing, straight edged portions are capable of engaging with said attachment ports in a desired locking manner; and
an attachment tool, wherein said attachment tool comprises portions capable of engaging said attachment members to a desired locked or unlocked position.

10. A securing device comprising:
at least one fixed member;
at least one insert member that may be engaged with an attachment tool to said fixed member, wherein said insert member comprises an insert body, and wherein said insert body further comprises portions defining attachment ports and wherein said attachment ports comprise an alignment slot and a locking portion; and
an attachment tool, wherein said attachment tool comprises portions capable of engaging said attachment members to a desired locked or unlocked position.

11. A method of using a securing device on an object, the securing device including at least one insert having a first shaped through hole and a second shaped partial through hole, and at least one attachment member with a head portion having a shape corresponding to the second shaped partial through hole, the method comprising:
attaching the at least one attachment member to the object;
aligning the head portion of the attachment member with the second shaped partial through hole of the at least one insert;
pressing the at least one insert against the object; and
tightening the attachment member such that the second shape of the head portion is perpendicular to the second shaped partial through hole of the insert.
